(19) United States
(12) Patent Application Publication
(10) Pub. No.: US 2002/0077937 A1
(43) Pub. Date: Jun. 20, 2002

(54) Apparatus and method for ensuring availability of inventory for electronic commerce

(76) Inventors: Kevin Lyons, Oakland, CA (US); Rehan Chawdry, Castro Valley, CA (US); William F. Matheny III, Castro Valley, CA (US); Dave Mathis, Saratoga, CA (US); Paul Rako, Sunnyvale, CA (US); Todd Murchison, Mountain View, CA (US); George Thomas, Tulsa, OK (US)

Correspondence Address: FISH & RICHARDSON P.C., 3300 DAIN RAUSCHER PLAZA, 60 SOUTH SIXTH STREET, MINNEAPOLIS, MN, 55402, US

(21) Appl. No.: 09/947,212

(22) Filed: Sep. 4, 2001

Related U.S. Application Data
(60) Provisional application No. 60/229,698, filed on Sep. 1, 2000.

(51) Int. Cl. G06F 17/60

(52) U.S. Cl. 705/28

(57) ABSTRACT

A method performed by a computer-implemented purchasing system includes receiving a first user input from a seller indicating a product identification for each of a plurality of goods, and one or more pickup locations, receiving a second user input from a buyer selecting at least one of the goods and one of the pickup locations, automatically delivering the order from the purchasing system to a fulfiller having a storage area, receiving confirmation in the purchasing system that the at least one of the goods is physically present in the storage area and is available for sale, and automatically notifying the buyer that the at least one of the goods is available at a pickup location.

### CROSS-REFERENCE TO RELATED APPLICATIONS

This application claims priority to Provisional U.S. Application Serial No. 60/229,698, filed on Sep. 1, 2001, the entirety of which is incorporated by reference.

### BACKGROUND

The present application relates to purchasing goods electronically and fulfilling the resulting orders.

Conventional electronic commerce systems permit a buyer to use the Internet or another electronic communication system to purchase goods from a seller. For electronic goods, such as software and music, the buyer can download data or files directly from the seller's web site. However, for physical goods, such as books or computers, the buyer and seller need to arrange for transfer of the goods. Typically, the seller relies on a third party shipper, such as Federal Express or UPS, to deliver the goods to the buyer. Alternatively, the buyer may schedule a time to pickup the goods at the location of the seller's inventory, e.g., at the seller's retail or wholesale outlet. Alternatively, the buyer may simply request that the seller hold the items aside for pickup at an unscheduled time.

Conventional electronic commerce systems also rely on an inventory tracking system to determine whether and how specific goods should be advertised or offered for sale and whether or how an order can be fulfilled. For example, the seller (or an intermediary purchasing system) can maintain a database that identifies a quantity of items in stock or available for sale for each particular good. After an electronic order is received, the database is updated automatically to reduce the number of items in stock or available for sale. When the database indicates that the stock of a particular good has run out, the web site (or other sales channel) can be updated so that the good is no longer listed for sale. Although this system can be satisfactory for sellers that maintain large inventories or have long delivery times, or operate solely by electronic commerce and use third party shippers, it poses some problems in other contexts.

First, buyers may want an urgent or rush pickup or delivery (e.g., by a courier). Second, buyers may want a confirmation that the ordered items are actually available in the quantity ordered, that the ordered items are in an acceptable condition, or that they will receive the ordered items when they arrive at a scheduled pick up time. Unfortunately, an inventory tracking system cannot ensure that the goods desired by a buyer will actually be available for pickup by the buyer or third-party shipper, particularly in urgent or rush transactions and where the seller maintains a small inventory. First, the inventory tracking system may not be updated on a regular basis. For example, items may be sold throughout the day, whereas the inventory tracking system might be updated each night. Second, even if the inventory tracking system is updated continuously throughout the day, when an electronic order for an item arrives, a customer actually present in the retail outlet may have removed the item from the shelves but not yet reached a checkout stand. Since the transaction has not been logged at the checkout stand, the inventory tracking system lists the item as available, even though it has been taken by another customer. As other examples, employees of the seller may fail to enter transactions properly, or may even steal goods. In both of these cases, there will be a discrepancy between the number of items in the inventory tracking system and the number of items actually available on the shelves. Thus, the item may not be available when the order is received or when the buyer arrives at a scheduled pickup time. In addition, one or more of the items may on hold, or may be damaged or not in a sellable condition.

Yet another problem is the large capital expense required for conventional wholesalers and retailers to establish an electronic presence to sell goods either over the Internet or through other electronic sales channels. For example, a significant investment may be needed to create a web site through which goods are offered for sale. Furthermore, there is a large capital expenditure in creating a centralized infrastructure to handle direct shipments of single orders to customers (which is even greater than the capital expenditure in a bulk shipping infrastructure to restock or replenish distribution centers or retail stores.

### SUMMARY

In one aspect, the invention is directed to a method performed by a computer-implemented purchasing system. The method includes receiving a first user input from a seller indicating a product identification for each of a plurality of goods, and one or more pickup locations, receiving a second user input from a buyer selecting at least one of the goods and one of the pickup locations, automatically delivering the order from the purchasing system to a fulfiller having a storage area, receiving confirmation in the purchasing system that the at least one of the goods is physically present in the storage area and is available for sale, and automatically notifying the buyer that the at least one of the goods is available at a pickup location.

Implementations of the invention may include one or more of the following features. The purchasing system may receive confirmation that the order has been delivered to the fulfiller, that the at least one of the goods has been physically removed from the storage area, that the at least one of the goods has been moved from the storage area to the pickup location, or that the buyer has received the at least one of the goods. An instruction may be delivered to a bank computer system indicating that a sale has occurred after the step of receiving confirmation. An instruction may be delivered to a delivery service to transport the at least one of the goods from the fulfiller to the pickup location. The pickup location is a storage locker, and the purchasing system may receive confirmation that the at least one of the goods has been placed in the storage locker or that the at least one of the goods has been removed from the storage locker. Automatically delivering the order may include one or more of sending an electronic mail message, sending a facsimile message, generating a web page, sending a telephone message from an automated telephone system, downloading a message to a personal digital assistant (PDA), and directing a page to a wireless pager. Automatically delivering the order may include activating an alarm at the fulfiller or printing a barcode.

The order may be delivered from the purchasing system to a plurality of fulfillers, and the at least one of the plurality of goods may be sold from a first of the plurality of fulfillers to respond to the order.

Advantages of the invention may include one or more of the following. The purchasing system combines the ease of electronic purchasing (e.g., searching, selecting and paying for goods over the Internet, by a web-enabled device, or by an automated interactive telephone service), with the convenience of immediate prepaid local pickup or local delivery and an assurance as to the availability of the goods being purchased electronically. Rush or urgent orders can be filled. Orders can be accepted and processed without interaction with the inventory tracking system. The availability of the goods is confirmed physically and thus with high validity. The sale can occur from a regional or local location rather than a centralized fulfillment center, so that the customer is given desirable pickup options and a shorter delivery distance or time.

### BRIEF DESCRIPTION OF THE DRAWINGS

FIG. 1 is a schematic diagram of a purchasing system that can be used to practice the present invention.

FIG. 2 is a flowchart illustrating a method performed with the purchasing system of the present invention.

FIGS. 3 and 4 are electronic circuit diagrams for a self-waking personal digital assistant (PDA).

FIG. 5 is a schematic diagram of a display of a personal digital assistant being used by the seller's employee to select items from storage.

### DETAILED DESCRIPTION

In brief, the invention relates to a purchasing system to which both buyers and sellers (collectively, “users”) can connect using either a computer or a telecommunication device. The purchasing system permits sellers to list the goods being sold, and permits buyers to search and select goods to purchase. In general, the seller can be an individual, retailer, wholesaler, distributor, or manufacturer, or a party (e.g., an order taker or broker) authorized to sell goods on behalf of the seller. However, the system is particularly useful to sellers, e.g., retailers or wholesales, with an inventory that is accessible to customers, i.e., when customers are permitted to physically enter the seller's premises to purchase goods. The system is also especially useful to sellers, e.g., retailers, that maintain a small to moderately sized inventory. The buyer can be an individual, retailer, wholesaler, distributor, or manufacturer. The purchasing system also allows the users to make mutually convenient delivery and pickup arrangements and to submit or receive orders by convenient media. In addition, the purchasing system also allows buyers to have local fulfillment of orders.

As previously noted, there are problems with the use of inventory tracking systems to determine whether a particular physical good is available for sale. Since there can be discrepancies between what is listed in the inventory tracking system and what is actually available on the shelves to be sold, the inventory tracking system cannot ensure that a particular physical good desired by a buyer will actually be available in stock for immediate pickup or delivery. In short, the only method to guarantee that a physical good is available for purchase is for the seller to actually check the shelves, stacks or other area where the goods are stored. Once the good has been located, it can be set aside for the buyer.

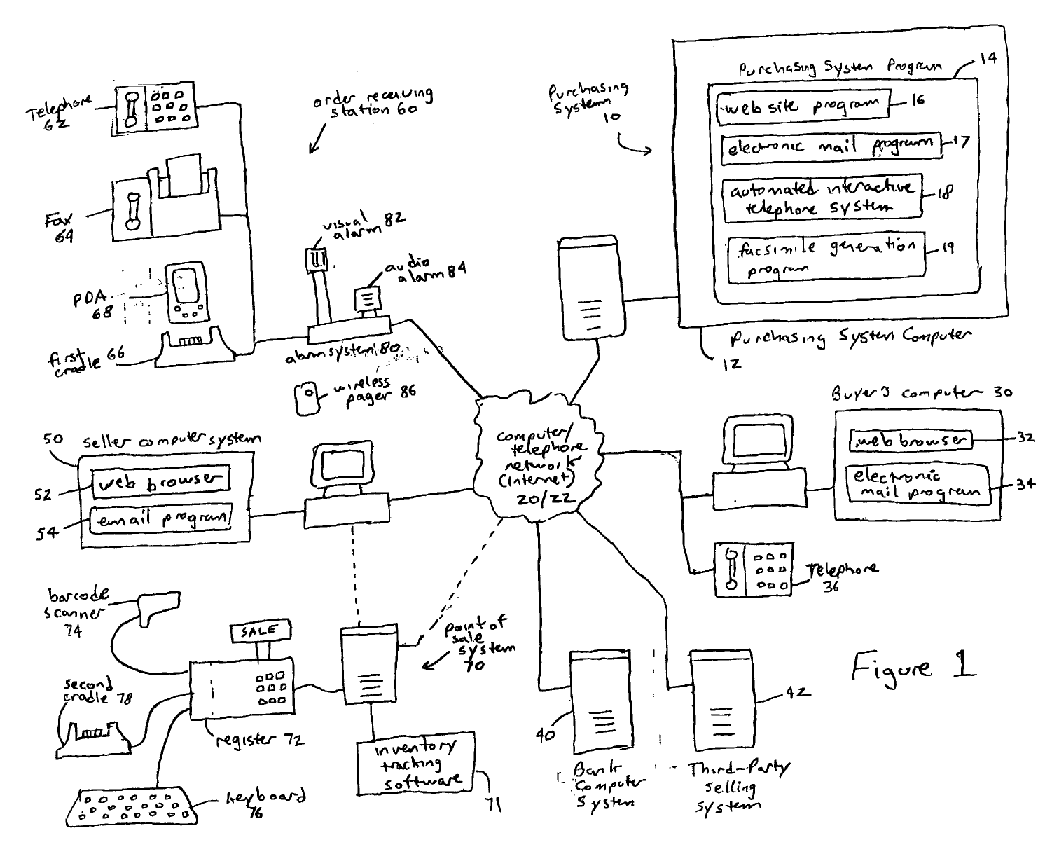

FIG. 1 illustrates a purchasing system 10 and its connection to a buyer, a seller and a bank. The purchasing system 10 includes a general purpose programmable digital computer system 12 (such as a personal computer or work station) of conventional construction, including a memory and a processor for running a purchasing system program 14. The purchasing system 10 will serve to take orders and otherwise coordinate transactions between the buyer and seller. The computer system 12 also includes conventional communications hardware and software by which the computer system can be connected to other computer systems, including a seller's computer system 30, a bank computer system 40, and a buyer's computer system 50, by a computer network 20, such as the Internet.

Specifically, the purchasing system program 14 on the purchasing system computer 12 can include a web site program 16 and an electronic mail program 17. The web site program 16 can be used to maintain a web site that is accessible to both buyers and sellers using the Internet and conventional web browser applications, whereas the electronic mail program can be used to send and receive electronic messages from the both buyers and sellers. The computer system 12 can also run an automated interactive telephone system 18 that can generate and received telephone calls via a telephone network 22 (possibly connected to the computer network 20 to form a single telephone and computer network) and a facsimile program 19 that can generate facsimile messages and send the facsimile messages on the telephone network 22.

The buyer typically has a buyer's computer system 30 that runs a web browser 32 and an electronic mail program 34. The buyer may also use other communication devices, such as a telephone or mobile phone 36 or a facsimile machine 38. Although illustrated as a computer, the buyer's computer system 20 may be another Internet-enabled or web-enabled electronic device, such as a television or cellular phone. In addition, the buyer could be using a stand-alone kiosk (or other stand-alone station such as a gasoline pump) that can communicate with the purchasing system 10 or the third-party selling system 42. This connection may a continuous or intermittent, may be over a fixed wire or a wireless system, and may be a direct network connection or an Internet connection. Although illustrated as a single computer, the buyer's computer system 30 can be a distributed system implemented on a network.

The purchasing system 10 is connected to one or more bank computer systems 40 by the Internet, as shown, or by a continuous or intermittent dataline connection. The bank computer system 40 executes applications that are conventional for electronic commerce. Although illustrated as a single computer, the bank computer system 40 can be a distributed system implemented on a network.

The seller typically includes one or more of the following: a seller's computer system 50, an order receiving station 60, and a point-of-sale sale system 70. The seller's computer system can run a web browser 52 and an electronic mail program 54. The order receiving station 60 can include a telephone 62, a facsimile machine 64, and a first cradle 66 for a personal digital assistant (PDA) 68. The order receiving station 60 can also include an alarm system 80 that can activate a visual alarm 82, an audio alarm 84 and/or a wireless pager 86. The point-of-sale system 70, which can be connected to the seller's computer system 50, can include a register 72 with a bar code scanner 74 and a keyboard 76, as well as a second cradle 78 for the PDA 68. The point-of-sale system 70 is typically part of a computer system that operates inventory tracking software 90. The order receiving station 60 and point-of-sale system 70 will be discussed in further detail below.

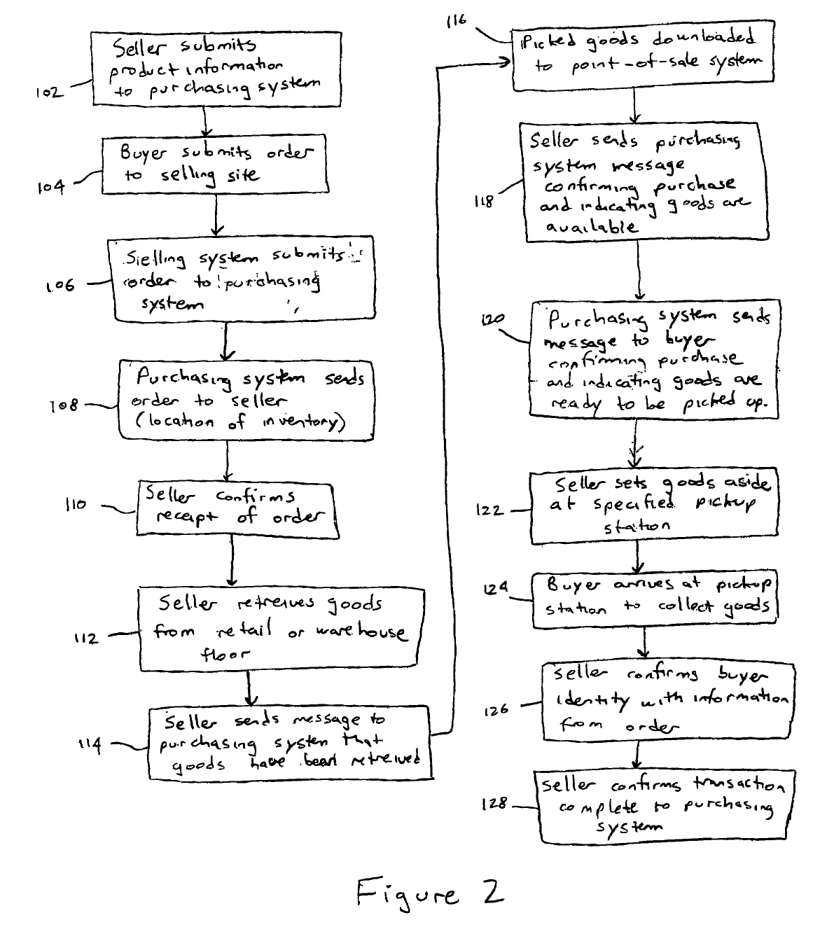

The overall method performed using the purchasing system is illustrated in FIG. 2. Initially, a seller can submit product information (or updates or changes to product information), such as the price and description of the goods the seller is offering, to the purchasing system (step 102). For example, the seller can send an electronic mail message to the purchasing system 10 with the product information in an attachment or embedded in the body of the message. A list of goods being offered can be generated manually or using a bar code scanner system. Alternatively, the seller could use the web browser 42 to visit the purchasing system web site and use tools available at the purchasing system web site to submit the product information. For example, the seller could fill out forms on a web page. Alternatively, the seller could have an inventory tracking system that is connected to the purchasing system 10, e.g., by the Internet or by a continuous or intermittent telephonic dataline connection that periodically sends the product information to the purchasing system. Alternatively, the seller could use the telephone 44 to access the automated interactive telephone system 16 and respond to an automated voice system to submit and update the product information, including price and availability. Alternatively, the product information could be sent by a regular telephone or facsimile message, and manually entered by an employee of the purchasing system. Alternatively, the seller can have virtually no updating of the product information, and can simply receive orders with no prequalifications or restrictions, much as in-store customers are handled.

Next, the buyer submits an order to the selling site (step 104). The selling site can be maintained by the seller, by the operator of the purchasing system, or by another third-party authorized to sell goods on behalf of the seller. The selling site can be a web site maintained by the seller on the seller's computer system 50, a web site maintained by the purchasing system 10, on a web site maintained by a third-party electronic commerce system 42. For example, the buyer can use the buyer's computer 20 to visit third party electronic commerce system 42, browse or search to identify products of interest, and then select the desired goods. The identified products can be part of predefined list, such as a wish list (e.g., a bridal registry) for another person. Alternatively, the buyer can use an internet-enabled device to send an electronic message to order the item. Alternatively, the buyer can use a telephone or cellular phone 36 to access an automated interactive telephone system, either in the seller's computer system 50, the purchasing system 10, or the third party system 42, and respond to an automated voice system to order the item. The order will typically include the goods being purchased and can specify a pickup or delivery option. In the context of a web site, the pickup or delivery option can be selected from a dropdown menu. Typical options can include immediate pickup at the seller, same day delivery, a scheduled pickup at the seller, or regular delivery.

The order may also include prespecified options if any of the goods are out of stock at a particular location. For example, the buyer may specify a range and/or ranking of store locations, product substitution rules (e.g., alternative product colors, product sizes or product classes), acceptable delivery or pickup times, or order cancellation conditions. In addition, the buyer may indicate a desire to contact the store directly to receive suggestions for substitutions or backordering. The seller may also offer specific product substitution options at the time that the order is taken.

Information concerning the products can be delivered to a third-party system 42 by the purchasing system. For example, the seller may submit the product information to the purchasing system with an authorization to post the goods for sale on a third party system.

Web pages or other useful information can be generated by the purchasing system and delivered to the seller's computer system 50 or the third party computer system 42. For example, the seller's web site may include a list of goods. After the buyer places the goods in an electronic cart, the buyer may provide location information and select a “Buy Locally” option on the seller's web page. This causes the seller to send an electronic message with the necessary product identification, such as a UPC number, SKU number, or product description to the purchasing system 10. In response, the purchasing system can use the information previously provided by the seller to generate an XML or similarly encoded message or web page formatted with information regarding the goods, e.g., a complete description of the goods along with the location of the stores near the buyer that stock the goods, the times that the goods can be picked up, and the pricing. The buyer can then view the web page on the seller's computer system or another communications device. Alternatively, the buyer can follow a link to the purchasing computer system to view the web page.

Eventually, the buyer completes the purchase (or hold or inventory check) information required for the goods. Assuming the purchase occurred using the third-party seller system 42, the third party's system sends the order to the purchasing system 10 (step 106). Typically, the order is sent electronically and is processed automatically by the purchasing system computer. However the order could also be sent by facsimile or telephone and entered automatically or manually by an operator of the purchasing system.

Once the purchasing system 10 has received and processed the order, the order is routed to a particular store or outlet of a seller (step 108). A distinction may be noted here between the seller's web site system and an individual retail or other fulfillment outlet. The seller's web site may be maintained by the corporate headquarters and may be on a completely separate computer system or at a separate location than the individual retail or fulfillment outlet. Thus, the retail location does not necessarily know about the purchase of any particular goods.

If the buyer selects an order with a limited time frame, such as a rush or urgent order, then the order sent to the seller can indicate that the seller has a preset time limit or deadline, e.g., five to thirty minutes, to confirm that the item is in stock or otherwise complete the steps of the ordering process. If the seller has the item in stock and responds to the order within the preset time limit, then the item is sold.

The order can be sent to the seller by nearly any communication method, and orders can be send independently, sequentially, in parallel or with other techniques to guarantee that the order is received. For example, the order can be sent by an electronic mail message to the seller's computer 50 using the electronic mail program 17, be sent by an electronic message that updates the seller's internal web site or intranet to display the new order, by a telephone message to the telephone 62 created by automated telephone system 18, by a facsimile to the seller's facsimile machine 64 created by the facsimile generation program 19, by downloading the order into the PDA 68 in the first cradle 66, by an alphanumeric page to the wireless pager 86 generated by automated telephone system 18, by a message appropriately formatted and sent directly to a point-of-sale (POS) system, or by a combination of these methods. The order identifies each purchased good, for example with a product ID, model number retailer SKU code or UPC code, and the customer's name, pick-up or delivery option (including desired pick-up time), and any authentification information.

The purchasing system may send an order to multiple sellers with different rankings and time limits. For example, the order may specify that the first seller has 15 minutes to respond, that the second seller has 30 minutes to respond, that the third seller has 45 minutes to respond, and so on. If the first seller does not reply, then the second seller is given the option of selling the goods by replying within the new time limit. Alternatively, orders can be sent out in parallel to multiple sellers, with the first seller to reply getting the sale.

Once the seller has received the order, the seller can confirm receipt to the purchasing system (step 16). The confirmation can be sent to the purchasing system by a telephone call to the automated interactive telephone system 18, by an electronic mail message, by user input to a web site operated by the purchasing system, or by an electronic reply generated by the PDA. In particular, the confirmation can use the same medium as the order. For example, if the order was sent by an automated telephone message, the seller may be given the option at the end of the message to punch in a key code to acknowledge receipt of the order. If the order was sent by electronic mail, the seller can reply to the electronic mail. If the order updated a web page, the seller may click a button on the web page to acknowledge receipt. If the order was sent to the PDA 68, the PDA may automatically respond with a confirmation. The confirmation can use the same medium or a different medium than the order.

In order to ensure timely processing of orders, the order receiving station 60 can include an alarm system 80. The alarm system can trigger a visual alarm 82, an audio alarm 84, or a wireless pager 86 upon receipt of an urgent order. If the telephone line 61 to the order receiving station is a dedicated line, then merely receiving an incoming signal on the line can trigger the alarm. However, if the telephone line 61 is a shared line, then the alarm system 80 can distinguish the incoming signals before generating the alarm.

For example, the alarm system can include either a caller ID function and/or a DTMF function, along with a microprocessor to match the information generated by the caller ID or DTMF to preset conditions that trigger the alarm. For example, if the caller ID matches the telephone number used by the purchasing system 10, then the microprocessor knows that the signal is an urgent order, and triggers the alarm. The alarm system 80 may also suppress the first ring of the telephone 62 of facsimile machine 64 to prevent extraneous noise (caller ID information is typically delivered between the first and second ring). If the alarm system includes a DTMF function, then the received tone signal can be used to reprogram the microprocessor, providing a way for the purchasing system 10 to remotely update the alarm system 80. Instead of being located between the communication devices and the main phone line, the alarm system 80 can be placed only on the telephone or facsimile line, or even be placed off the handset line from the phone or fax. An advantage of the later configuration is that the handset line is an analog line, ensuring compatibility with DTMF, even if the seller uses a digital telephone PBX. Thus the alarm system 80 can be installed without significant modification of the seller's existing phone system.

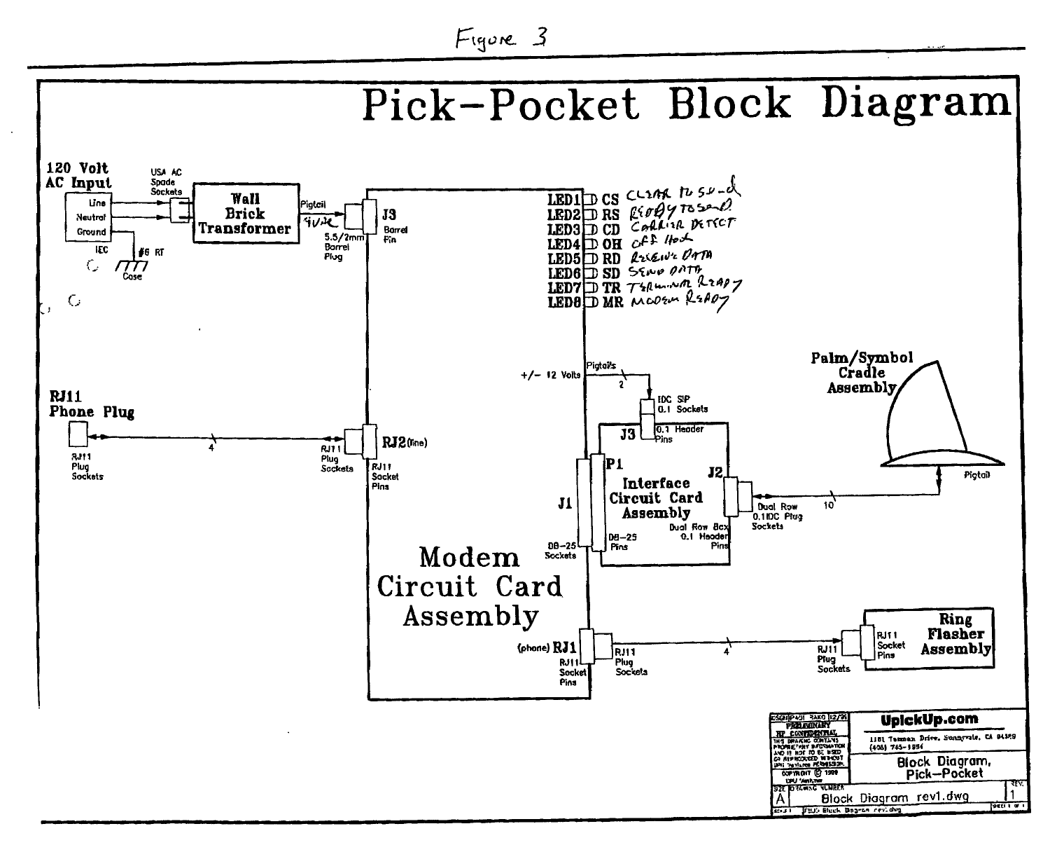

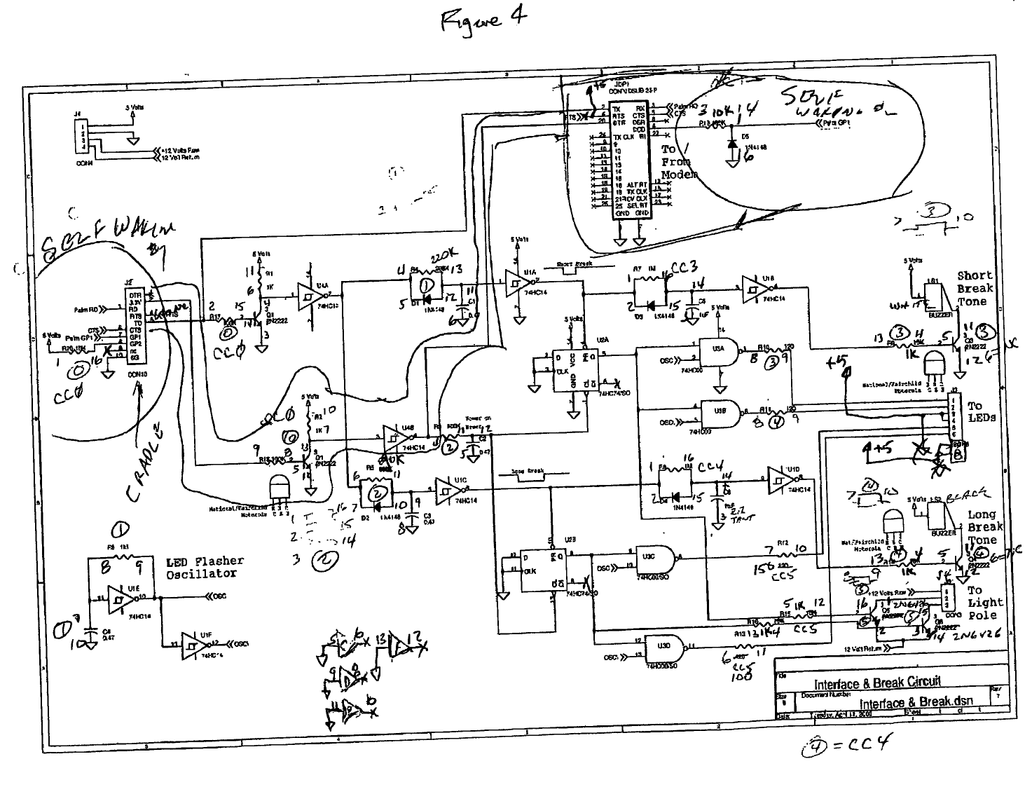

In one implementation, the seller maintains an order receiving station 60 includes a personal digital assistant (PDA) device 68, such as a Palm™ organizer equipped with a bar code reader. The PDA device 68 can be connected by a cradle 66 that includes a modem to the telephone line 61. In this implementation, when the purchasing system generates an order for the seller, the computer system 12 generates a telephone call to the modem in the cradle 66. The cradle 66 is configured to cause the PDA device to activate on “wake up” once a telephone signal is received. Once the PDA has been actuated, the purchasing system 10 begins two-way electronic communication with the software in the PDA 68. This permits the purchasing system 10 to download the order information through the modem into the PDA device 68. Once the PDA has received the order, the PDA can send an acknowledgement confirming receipt of the order. The cradle system 66 may be integrated with the alarm system 80, so that the cradle triggers a visual or audio alarm when it receives a message from the purchasing system. Alternatively, the PDA 68 and cradle 66 could trigger the alarm when the complete order has been received. FIGS. 3 and 4 illustrate a circuit diagram for a self-waking PDA and alarm.

If the purchasing system 10 does not receive a confirmation of the order, it can send one or more alarms or reminders, in the form of additional electronic pages, telephone calls, facsimile messages, electronic mail messages, web site updates, downloads to the PDA, or electronic messages that trigger a local alert such as a local pager or audio or visual alarm. In addition, if the PDA 68 receives an order, but is not removed from the cradle 66, software in the PDA 68 can send additional signals to repeatedly activate the alarm. Alternatively, if no confirmation is received, the purchasing system 10 can send the order to a different seller.

In addition, the seller may specify, elect or consent to an “escalation scheme”. In general, the escalation scheme identifies the sequence of actions for the purchasing system to take if it does not receive confirmation of an order, confirmation that the goods are available for pickup or have been retrieved, or that other steps in the process have not be achieved. Actions can include a combination or sequence of additional messages, messages by alternative media (e.g., by telephone if the original facsimile number is busy or results in an error), messages to alternative locations (e.g., a different telephone number if the telephone number is busy or an alternative electronic mail address if the electronic mail message bounces), by contacting an alternative individuals at the storage location of the inventory (e.g., if the order is acknowledged but no update is received), or by contacting customer service or corporate management of the seller (e.g., if one or more of the preceding steps fail). These messages may include processing instructions, system tests, retransmittal requests, or other types of messages.

After the seller receives the order, the seller finds the goods, e.g., in storage or from the wholesale or retail floor (step 112). An employee of the seller can create a “pick list” that is used when finding and/or pulling goods from the shelves. As each item is found and/or pulled, it is checked off the pick list. The pick list can be provided with or as part of the order from the purchasing system. For example, if the order is sent by electronic mail message, then an attachment to the message can include the pick list. If the order is sent by updating a web site, then the web page can include a pick list. By printing the attachment to the message on the web page, the employee prints the pick list. If the order is downloaded to the PDA, then the display screen of the PDA can serve as a pick list. A facsimile message can have the pick list in its contents. The pick list may include a bar code for each good in the list. This bar code may later be scanned at the point of sale system.

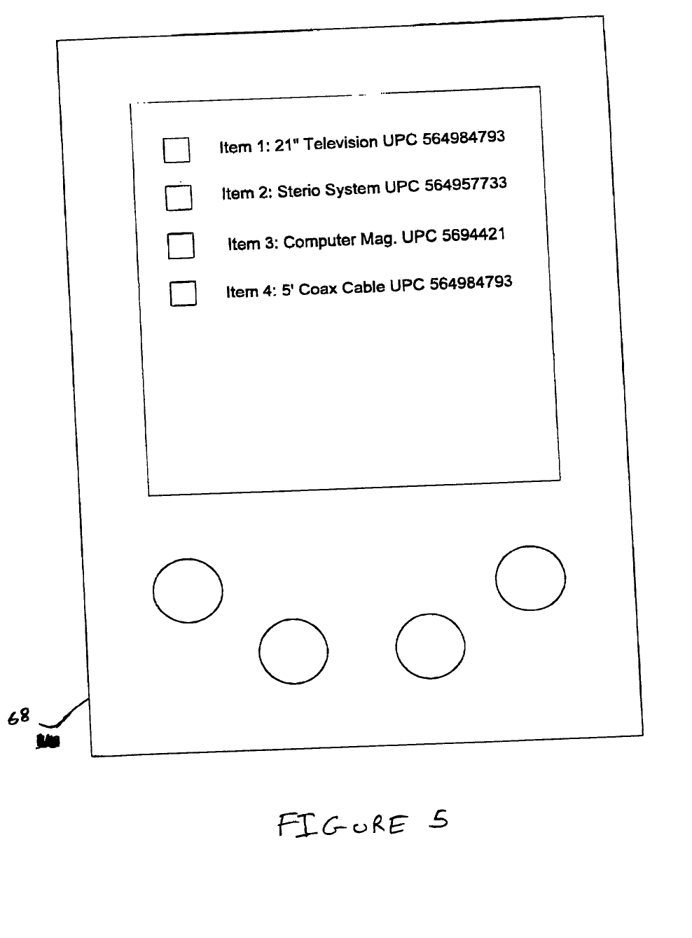

Referring to FIG. 5, the PDA 56 can display a list of the ordered items for the employee to retrieve. As the employee retrieves each item, the employee can either check a box on the PDA 56 screen next to the item description to indicate that the item has been picked. Alternatively, if the PDA 56 includes a bar code scanner 59, the employee scan the item as it is pulled from the shelf. The software in the PDA 56 determines whether the scanned item matches one of the items in the list, e.g., by comparing UPC or other identifying item codes.

Once the item has been picked from the shelves, the product codes for the items are downloaded into the seller's sales system 60 (step 112). The sales system 60 recognizes each product code and performs one or more actions, such as recording the sale and decrementing the inventory records for the goods.

In one implementation, the product codes for the items marked as picked in PDA in step 110 are downloaded from the PDA 56 to the sales system 60. Returning to FIG. 1, the sales system 60 is typically located at a checkout stand and includes a computer system 62 and conventional input devices, such as a keyboard 64 or a bar code scanner 66. In addition, the sales system 60 includes a cradle 70 and a splitter or wedge 72 that connects the cradle 70 to a line 74 between one of the input devices 64 or 66 and the computer system 62. The PDA 68 includes software that emulates the output of one of the input devices. For example, if the second cradle 78 is connected to the line between the register 72 and the keyboard 76, then the PDA 68 includes software to emulate the sales system keyboard 76.

In operation, when the employee returns to the checkout stand with the picked goods, the employee places the PDA 68 in the second cradle 78. This causes the software in the PDA 68 to output signals that simulate the output that would occur if the employee had entered the product information for a sale on the keyboard 76 by hand. Specifically, the PDA 68 transmits a list of product codes, e.g., UPC or SKU codes, to the point-of-sale system 60, along with payment information, such as a credit card number of the buyer. The inventory tracking system records the sale and the number of available items is decremented in the database.

Alternatively, the employee can scan the goods that have been picked using the bar code scanner 74. If no bar code has been placed on the goods, or if the goods are elsewhere or are already packaged, then the employee can scan the bar code on the pick list printed by the facsimile, from the electronic mail message or from the web page.

Alternatively, some or all of the goods at the fulfillment location can include a radio frequency identification (RFID) tag in the goods or packaging. For these goods, the selling or purchasing system may “ping” the inventory to determine whether the goods are in stock. This step could be performed before the order has been placed or before the goods have been picked, and an indication that the goods are in stock can be sent to the purchasing system 10 by phone, two-way pager, internet web page, electronic mail message, point of sale system, or the like. In addition, the seller's system may periodically (e.g., nightly) update information about the actual goods in local inventory. This permits additional information to be provided to the purchasing system, such as the number of goods in stock. In addition, the seller's system or the purchasing system can be configured to calculate a projected quantity, availability status (e.g., probably in stock, maybe in stock, unlikely to be in stock), or a degree of confidence that the goods will be available based on the time of day and/or day of the week that the order arrives or is scheduled for pickup or delivery, based on prior sales history and the most recent inventory calculation.

As the availability of each of the requested items in the order is checked at the order fulfillment location, a confirmation of the item's availability and other item information, e.g., a quantity in stock and/or price, can be sent to the purchasing system. This message can be sent manually by electronic mail, by calling the interactive automated telephone system 18, by returning the PDA 68 to the first cradle 66, or by a regular telephone or facsimile message that is input into the purchasing system by an operator or employee of the purchasing system. Returning the PDA to the first cradle 66 can cause software in the PDA 68 to download the sales information to the purchasing system 10.

In the event that the one or more of the items is not in stock, or in the event that there is an insufficient number of items in stock, this information can be sent to the purchasing system (using any of the various media previously discussed), along with substitute offers or suggestions. The purchasing system can then relay this information to the buyer, or otherwise take action in accordance with out-of-stock handling instructions associated with the original order.

The system can be set with various out-of-stock handling instructions or other contingencies. For example, the buyer can pre-specify what should occur if the seller is unable to fulfill one or more goods from the order. Alternatively, the buyer can be informed if the seller is unable to fulfill the order, and can choose an option at that time. Common options include having the seller hold the available goods until the missing goods arrive, sending an order for the missing goods to a different seller, on sending the entire order to a different seller.

In general, if the goods (or prespecified alternative goods) are not in stock, a message is sent to the buyer. The purchasing system can include a communication system, such as a interactive messaging system or chat system, that permits the buyer to consult with seller. The buyer can use the communication system to consult with the seller to select new goods, or can cancel the order entirely.

In general, if any item are out-of-stock, the seller waits for out-of-stock handling instructions from the buyer while the buyer is automatically contacted by the purchasing system. These new order instructions are then are received and acted in a fashion similar to the original order, and the process is repeated until the full list of original or revised items and is confirmed available for the buyer.

Once the goods have been retrieved and scanned, rung up, bagged, gift wrapped, packaged, labeled or otherwise prepared, the seller can send the purchasing system a message indicating that the goods are ready to be picked up or delivered (step 118).

For example, the sales system 70 can send an electronic mail message to the purchasing system 10 to confirm that the goods are available and have been sold (step 114). The POS system or credit card authorization system can be used to send a message to the purchasing system once the order has been rung up or authorized.

The purchasing system 10 can then send a message to the buyer, e.g., by electronic mail, automated phone call, pager, short text messaging (SMS), facsimile, or the like, to confirm that the purchase has been performed (step 120). If the order is to be couriered, delivered or shipped by a party other than the buyer or seller, then the purchasing system can sent a message to the third party delivery service. In addition, once the item has been purchased, the seller's employees can set the goods aside at a specified pickup location (step 122). Finally, the buyer or deliverer arrives at the specified pickup location at or after the pickup notification or scheduled pickup time and collects the goods (step 124). When the buyer arrives at the pickup location, he or she typically presents identification, such as a name, picture identification, or credit card, signs a receipt, and leaves with the ordered products (step 126). Since the buyer an prepay and has a scheduled a time for pickup, lines can be eliminated and fulfillment times for these orders can be dramatically decreased. If a product is not picked up within a certain amount of time, the purchasing system can send the customer a reminder by electronic mail, automated phone system, or the like, that the product is waiting for pickup.

Once the buyer (or deliverer) has taken possession of the goods, the seller can send a confirmation message to the purchasing system 10 indicating that the transaction is complete. Like the other messages, this confirmation may be performed with electronic mail, by web site interaction, via the automated interactive telephone system 16, and so forth.

Rather than picking up the goods at a staffed store location, the buyer may elect to have the goods placed in or delivered to a locker for pickup. The locker is connected to a computer system, which can be either a stand-alone computer system or connected to the seller computer system or the purchase order system. In general, the seller or third-party delivery service scans the barcodes or types in the order ID codes for the goods being placed in the locker, and the computer system offers or assigns one or more of the available locker compartments for storage of the ordered items.

A password or access code can be assigned to the particular locker compartment storing the buyer's goods. Typically, the locker system includes a credit or debit card-swipe system, so the access code can be some or all of the information on the magnetic stripe of the credit card. Thus, when the buyer arrives, the buyer need merely swipe with the appropriate card (e.g., the card used to purchase the goods) in order to open the locker. If the computer is a stand-alone system, the access code can be entered by the seller or third party delivery service, e.g., by downloading the access code to a PDA and then downloading from the PDA to the locker computer. If the computer is connected via a network or the Internet, then the information from a swiped credit card can be compared to information stored locally or at the seller's computer or the purchasing system. Of course, in addition to or instead of a credit card reader, the system can other input devices such as a keypad or keyboard and use a personal identification number (PIN) that is used by the buyer.

Assuming that the locker is coupled intermittently or continuously to the seller's computer or the purchasing system, the purchase order system can be updated to indicate that the goods have been retrieved once the buyer accesses the locker to retrieve their order.

One advantage of the present system is that the buyer, seller, and other parties can access the purchasing system to track the status of orders. For example, by logging onto the purchasing system, the buyer or seller can determine whether an order has just been received, whether it has been confirmed available by the seller, whether the goods have been retrieved, and whether the buyer has taken the goods and the transaction is complete. Of course, access to such information may be restricted. For example, sellers may have different access rights than sellers or third parties, and store employees may have different access rights than managers.

The efficiency of updating the purchasing system with the status of an order can be improved with the use of speed codes. When a buyer submits an order to the selling site, the purchasing system 10 can generate a specific code for the seller to use when updating the purchasing system. For example, the purchasing system can create a string of numbers for each order that represent various actions (e.g., confirming that the order has been received, or confirming that the goods are available, or confirming that the goods have been picked up) for the particular order. Each speed code and a description of the associated action can be provided on the same printout as the order, particularly if sent by facsimile or electronic mail message. The employee of the seller can then refer to the order to determine which code to use for which action. Since only a limited number of orders exist at one time, the speed codes can be shorter than the full identification code (e.g. SKU or UPC code) of the goods. This reduces the time needed to update the status of an order using the interactive telephone or other communication system. Once used, the speed codes can be recycled.

The speed codes may be presented as short number strings for easy of entry. The strings can correspond to meaningful information (e.g., a store ID number, a chain ID number, or a portion of the order number), or the strings can be randomized to provide security and deter reverse engineering. In addition, the purchasing system 10 can assign speed codes that differ in more than one digit locations from other active speed codes. This ensures that users do not mistakenly update another order by accidentally pressing one wrong key or otherwise selecting the wrong digit.

One particular use of the purchasing system 10 is for “immediate handling” or “premium handling” in electronic commerce. Specifically, the purchasing system 10 can charge buyers a surcharge for a quick response in acknowledging that the buyer has purchased an item, confirming that an item is actually available, or ensuring that an item has been set aside for immediate pickup by the buyer. This is possible because 1) the seller can receive an immediate visual or audio alarm indicating that an order has arrived, 2) the seller's employees can quickly find and pull the item from the storage area (or declare that the item is unavailable), 3) the seller can easily input information about the items pulled from the shelves into a point-of-sales system, and 4) no purchase occurs until the sellers has confirmed that the goods are actually present in inventory. Another advantages of the system, particularly to a retail outlet, is that the order receiving station 50 can interface with an existing point-of-sale system with no modification or only minimal modification, thereby eliminating or reducing the need for capital investment.

The methods performed by the purchasing system program can be implemented in hardware, firmware, software, or combinations thereof, and instructions to carry out the methods can be stored in a computer program product tangibly embodied in a computer readable storage device. Storage devices suitable for tangibly embodying the computer program include all forms of non-volatile memory, including semiconductor memory devices, magnetic disks, including removable “floppy” disks, magneto-optical disks, and optical disks.

What is claimed is:

1. A method performed by a computer-implemented purchasing system, comprising:
receiving a first user input from a seller indicating a product identification for each of a plurality of goods, and one or more pickup locations;
receiving a second user input from a buyer selecting at least one of the goods and one of the pickup locations;
automatically delivering the order from the purchasing system to a fulfiller having a storage area;
receiving confirmation in the purchasing system that the at least one of the goods is physically present in the storage area and is available for sale; and
automatically notifying the buyer that the at least one of the goods is available at a pickup location.

2. The method of claim 1, further comprising receiving confirmation that the order has been delivered to the fulfiller.

3. The method of claim 1, further comprising receiving confirmation that the at least one of the goods has been physically removed from the storage area.

4. The method of claim 1, further comprising receiving confirmation that the at least one of the goods has been moved from the storage area to the pickup location.

5. The method of claim 1, further comprising receiving confirmation that the buyer has received the at least one of the goods.

6. The method of claim 1, further comprising delivering an instruction to a bank computer system indicating that a sale has occurred after the step of receiving confirmation.

7. The method of claim 1, further comprising delivering an instruction to a delivery service to transport the at least one of the goods from the fulfiller to the pickup location.

8. The method of claim 1, wherein the pickup location is a storage locker.

9. The method of claim 8, further comprising receiving confirmation that the at least one of the goods has been placed in the storage locker.

10. The method of claim 8, further comprising receiving confirmation that the at least one of the goods has been removed from the storage locker.

11. The method of claim 1, wherein automatically delivering the order includes one or more of sending an electronic mail message, sending a facsimile message, generating a web page, sending a telephone message from an automated telephone system, downloading a message to a personal digital assistant (PDA), and directing a page to a wireless pager.

12. The method of claim 1, wherein automatically delivering the order includes activating an alarm at the fulfiller.

13. The method of claim 1, wherein automatically delivering the order includes printing a barcode.

14. The method of claim 1, further comprising delivering the order from the purchasing system to a plurality of fulfillers.

15. The method of claim 14, further comprising selling the at least one of the plurality of goods from a first of the plurality of fulfillers to respond to the order.
